(19) United States
(12) Patent Application Publication
(10) Pub. No.: US 2004/0238661 A1
(43) Pub. Date: Dec. 2, 2004

(54) Gas hydraulic airless sprayer

(76) Inventors: James C. Schroeder, Ramsey, MN (US); Mariusz J. Luczak, Elk River, MN (US); William Blenkush, Becker, MN (US)

Correspondence Address: Douglas B Farrow, Graco Minnesota Inc, Intellectual Property Counsel, PO Box 1441, Minneapolis, MN, 55440-1441, US

(21) Appl. No.: 10/481,098

(22) PCT Filed: Jul. 12, 2002
(86) PCT No.: PCT/US02/23299

Related U.S. Application Data
(60) Provisional application No. 60/305,201, filed on Jul. 13, 2001.

(51) Int. Cl. B05B 3/00

(52) U.S. Cl. 239/722

(57) ABSTRACT

The frame 12 of a gas hydraulic sprayer 10 has a rear bumper 12a to be tilted up so that the immersion or suction tube 14 clears a paint container and rests on the bumper 12a. The hydraulic motor 16 consists of a piston 38 with a magnet 41, two sensors 47, a solenoid valve 32 and a microprocessor 18 which directs fluid through a solenoid operated valve 32 to the top or bottom of the piston 38. A secondary cooler or radiator 20 is made of tubing and attached to the hydraulic pump case 22 and routed in front of the fan and back to the oil reservoir.

### TECHNICAL FIELD

This application is a continuation-in-part of U.S. Application Ser. No. 60/305,201, filed Jul. 13, 2001.

### BACKGROUND ART

Gas hydraulic powered airless sprayers have proven popular for painting at sites where electricity is unavailable, particularly when large quantities of material need to be applied, such as through multiple guns. Such units are traditionally very heavy and have been sensitive to overheating of the hydraulic fluid. This overheating can happen during unit stall, that is, when the unit is running but not spraying. Heat generation takes place through (1) pressure drops through lines, ports and valves; and (2) hydraulic pump internal leakage during operation (often known as case drain).

### DISCLOSURE OF THE INVENTION

A secondary cooler is made of ⅜″ OD copper tubing and attached to the hydraulic pump case and routed in front of the fan and back to the oil reservoir. This results in increased hydraulic unit component life and delivers a smooth flow of paint to the gun.

The frame of the gas hydraulic sprayer is designed with a rear bumper so that the unit may be tilted up to that the immersion or suction tube clears a paint container (typically a five gallon pail) and rest on the bumper. This allows the painter to switch paint pails without having to hold up a heavy sprayer.

Instead of traditional mechanical spool valves, the instant invention consists of a hydraulic piston 38 with a magnet 41, two sensors 47, a solenoid valve 32, a microprocessor control and an on-off switch. In operation, in the retracted position magnet 41 on piston 38 generates a magnetic field to actuate the top sensor 47 which sends an electrical signal to the microprocessor. The solenoid operated valve 32 is commanded to shift which directs fluid to the top of the piston and the piston is driven down (to the extended position). When the piston reaches bottom, a signal is then sent to the microprocessor and the directional valve 32 shifts to direct fluid under the piston 38 which is then driven up (to the retracted position).

Controlling hydraulic motor direction via electronic sensors and microprocessor allows more precise control of changeover timing and protects the motor from stalling at changeover. This arrangement also allows the use of a simple on/off switch as opposed to the mechanical ball valve of traditional gas hydraulic units.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a perspective view showing the instant invention.

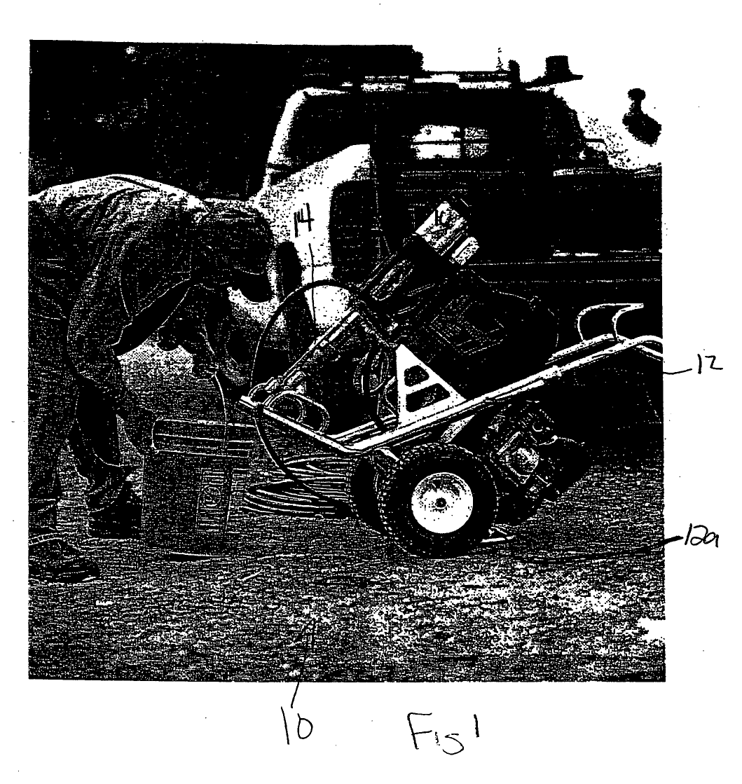

FIG. 2 is an exploded view showing the pump of the instant invention.

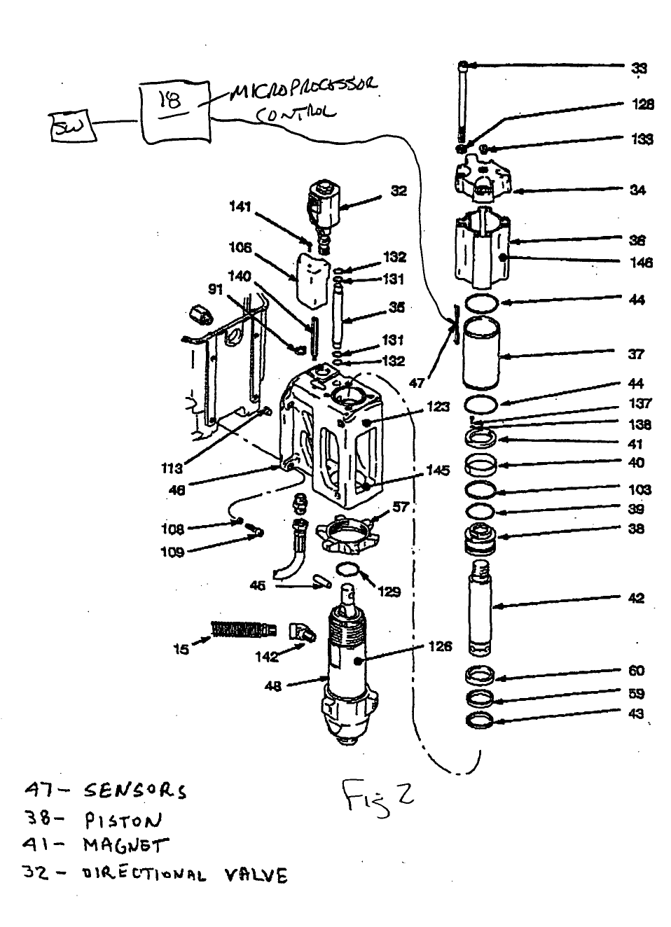

FIG. 3 is a front view showing the cooler of the instant invention.

### BEST MODE FOR CARRYING OUT THE INVENTION

The frame 12 of the gas hydraulic sprayer 10 is designed with a rear bumper 12a so that the unit may be tilted up so that the immersion or suction tube 14 clears a paint container (typically a five gallon pail) and rests on the bumper 12a. This allows the painter to switch paint pails without having to hold up a heavy sprayer.

Instead of traditional mechanical spool valves, the reciprocating hydraulic motor 16 of the instant invention consists of a hydraulic piston 38 with a magnet 41, two sensors 47, a solenoid valve 32, a microprocessor control 18 and an on-off switch. In operation, in the retracted position magnet 41 on piston 38 generates a magnetic field to actuate the top sensor 47 which sends an electrical signal to the microprocessor 18. The solenoid operated valve 32 is commanded to shift which directs fluid to the top of the piston 38 and the piston 38 is driven down (to the extended position). When the piston 38 reaches bottom, a signal is then sent to the microprocessor 18 and the directional valve 32 shifts to direct fluid under the piston 38 which is then driven up (to the retracted position).

Controlling hydraulic motor direction via electronic sensors 47 and microprocessor 18 allows more precise control of changeover timing and protects the motor 16 from stalling at changeover. This arrangement also allows the use of a simple on/off switch as opposed to the mechanical ball valve of traditional gas hydraulic units.

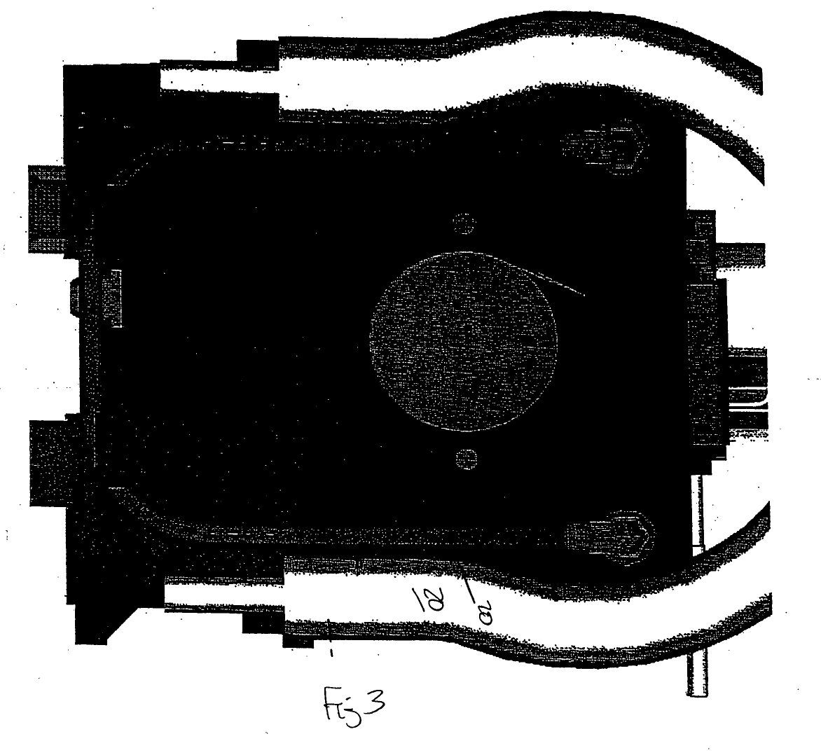

A secondary cooler or radiator 20 is shown in FIG. 3 and is made of ⅜″ OD copper tubing and attached to the hydraulic pump case 22 and routed in front of the fan and back to the oil reservoir. This results in increased hydraulic unit component life and delivers a smooth flow of paint to the gun.

It is contemplated that various changes and modifications may be made to the gas hydraulic airless sprayer without departing from the spirit and scope of the invention as defined by the following claims.

1. A hydraulic sprayer having a reciprocating hydraulic motor comprising:
a reciprocating hydraulic piston having a top, a bottom and magnet thereon and traveling between first and second end positions;
a solenoid directional valve for alternately directing hydraulic fluid to said piston top or bottom;
first and second sensors located adjacent said end positions; and
a microprocessor control connected to said solenoid directional valve and said first and second sensors.

2. A hydraulic sprayer having a cart, a hydraulic power supply and a pump with an immersion tube thereon, said cart comprising at least first and second wheels and a bumper portion, said cart being pivotable about said wheels between a first operating position and a second operating position wherein said cart is able to rest on said bumper and said immersion tube is raised a sufficient distance to allow access to a fluid container.

3. A hydraulic sprayer having a reciprocating hydraulic motor, a rotary power source having a fan producing an airstream thereon, a hydraulic pump, a hydraulic reservoir, the improvement comprising a radiator fluidly attached between said reservoir and said hydraulic pump, said radiator being in said fan airstream.
